(19) United States
(12) Patent Application Publication
(10) Pub. No.: US 2005/0019115 A1
(43) Pub. Date: Jan. 27, 2005

(54) Tool and method for forming a valve stem hole

(76) Inventors: Geoffrey L. Gatton, Farmington, MI (US); Dave Seiler, Fort Wayne, IN (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/744,116

(22) Filed: Dec. 22, 2003

Related U.S. Application Data
(60) Provisional application No. 60/489,826, filed on Jul. 24, 2003.

(51) Int. Cl. B23B 39/02

(52) U.S. Cl. 408/30

(57) ABSTRACT

A single stepped tool having spiral flutes and a method for using the tool to cut a stepped valve stem hole through the sidewall of a vehicle wheel.

### CROSS REFERENCE TO RELATED APPLICATIONS

This application is a continuation of pending provisional application Ser. No. 60/489,826 filed Jul. 24, 2003.

### BACKGROUND OF THE INVENTION

This invention relates in general to the manufacture of vehicle wheels and in particular to a tool and method for forming valve stem holes.

Vehicle wheels include an annular wheel rim that supports a pneumatic tire. A wheel disc typically extends across the outboard end of the wheel rim and is formed having a pleasing esthetic shape. The wheel disc usually includes a central hub supported within the rim by a plurality of radially extending spokes. Apertures formed through the wheel hub allow attachment of the wheel to a vehicle axle. Additionally, an aperture is formed through the sidewall of the outboard end of the wheel that receives a valve stem. The valve stem is used to inflate the tire mounted upon the wheel.

Light weight vehicle wheels cast from alloys of aluminum, magnesium and titanium have become increasingly popular. Such wheels may be cast as one piece and then finished with a number of machining operations or assembled from several components that also are machined to final dimensions. Regardless of the method used, the manufacture of vehicle wheels is highly automated.

One of the steps required to manufacture a vehicle wheel is the forming of the valve stem hole through the sidewall of the vehicle wheel. The valve stem is inserted into the valve stem hole from the inner side of the hole and pulled through the hole by a conventional valve stem mounting tool. The valve stem is seated upon a land formed across the bore of the valve stem hole and includes a valve that functions to control admission and release of air contained within the tire.

Referring now to the drawings, a typical valve stem hole 10 is illustrated in FIG. 1 that extends through a portion of the outboard end of a vehicle wheel 12, as shown in section. A valve stem 14 mounted in the hole 10 is outlined with dashed lines. The valve stem hole 10 extends through a sidewall 16 of the wheel 12 and beneath a tire bead seat 18. As described above, the valve stem 14 is inserted from the inboard end 20 of the valve stem hole 10. As also shown in FIG. 1, the valve stem hole 10 includes an outboard end counterbore 22. The inboard end of the valve stem hole 10 terminates an inboard chamfer 24. Similarly, an outboard chamfer 26 is formed in the base of the counterbore 22. A land 28 is formed between the inboard and outboard chamfers 24 and 26 and has a diameter that is less than the diameter of the counterbore 22. The land 28 cooperates with a reduced diameter portion of the valve stem 14 to retain the valve stem 14 within the valve stem hole 10.

The valve stem hole 10 is formed with a highly automated process that is illustrated by the flow chart shown in FIG. 2. The process begins in functional block 30 with the wheel being clamped upon a wheel drilling machine jig with the outboard end facing a multiple tool drilling head. A plurality of tools used to form the valve stem hole 10 are mounted upon the multiple tool drilling head that is indexed as the specific tool is needed. Then, in functional block 31, a pilot hole is drilled through the wheel sidewall with a twist drill. Next the outboard end of the hole is counterbored with a counterbore tool in functional block 32. A chamfer tool is used in functional block 34 to form the outboard chamfer 26 in base of the counterbore 22. The wheel is then rotated upon the wheel drilling machine jig in functional block 35 to expose the inboard surface of the sidewall and the inboard chamfer is formed in functional block 36. Finally, a deburring tool is used in functional block 38 to debur the inboard end of the valve stem hole 10.

As described above, the process for forming a valve stem hole requires numerous machining operations and a number of different tools. Accordingly, it would be desirable to reduce the number of machining operations and the number of tools to reduce both the time required to finish a wheel and the number of different tools that must be carried in inventory at the manufacturing facility.

### SUMMARY OF INVENTION

This invention relates to a tool and method for forming valve stem holes in the sidewall of a vehicle wheel.

The present invention contemplates a tool having for forming a valve stem hole through the sidewall of a vehicle wheel that includes an end portion having a first diameter that is formed as a spiral fluted drill. The tool also includes a second portion formed as a counterbore tool also having spiral flutes, the second portion having a second diameter that is greater than the first diameter of the end portion. Additionally, the tool includes an intermediate portion formed between the end portion and the second portion, the intermediate portion having a diameter that is less than the first diameter of the end portion. The tool end portion further includes a first chamfer cutting portion adjacent to the intermediate portion while the second portion includes a second chamfer cutting portion adjacent to the intermediate portion.

The present invention also contemplates a method for forming a valve stem hole through the side wall of a vehicle wheel that includes the steps of providing the tool described above and then using the tool to drill a pilot hole through a wheel sidewall with the drill end of the tool. As the pilot hole is drilled, the second portion of the tool form a counterbore in one end of the pilot hole. The tool is next rotated and moved in a radial direction within the pilot hole. While the tool continues to rotate, the tool is moved in a circular motion to increase the size of the counterbore while continuing to rotate the tool. In the preferred embodiment, the tool rotation and circular motion are opposite directions to provide climb cutting of the final counterbore diameter while also polishing the counterbore wall. Additionally, the chamfer cutting portions of the tool cut chamfers into the ends of the remaining pilot hole. Alternately, the tool may moved in circular arc simultaneously with the radial movement.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is sectional view of a portion of a portion of an outboard end of a vehicle wheel that includes a valve stem hole.

FIG. 2 is a flow chart illustrating a known method for forming the valve stem hole shown in FIG. 1.

FIG. 3 is drawing of a single tool for forming a valve stem holes that is in accordance with the present invention.

FIG. 4 is a view of an enlarged portion of the tool shown in FIG. 3.

FIG. 5 is flow chart illustrating a method in accordance with the present invention for forming the valve stem holes that utilizes the tool shown in FIG. 3.

FIG. 6 is a sectional view of a portion of a vehicle wheel that illustrates the beginning of the first step of the flow chart shown in FIG. 5.

FIG. 7 is a sectional view of a portion of a vehicle wheel that illustrates the conclusion of the first step of the flow chart shown in FIG. 5.

FIG. 8 is a sectional view of a portion of a vehicle wheel that illustrates the second step of the flow chart shown in FIG. 5.

FIG. 9 is a sectional view of a portion of a vehicle wheel that illustrates the third step of the flow chart shown in FIG. 5.

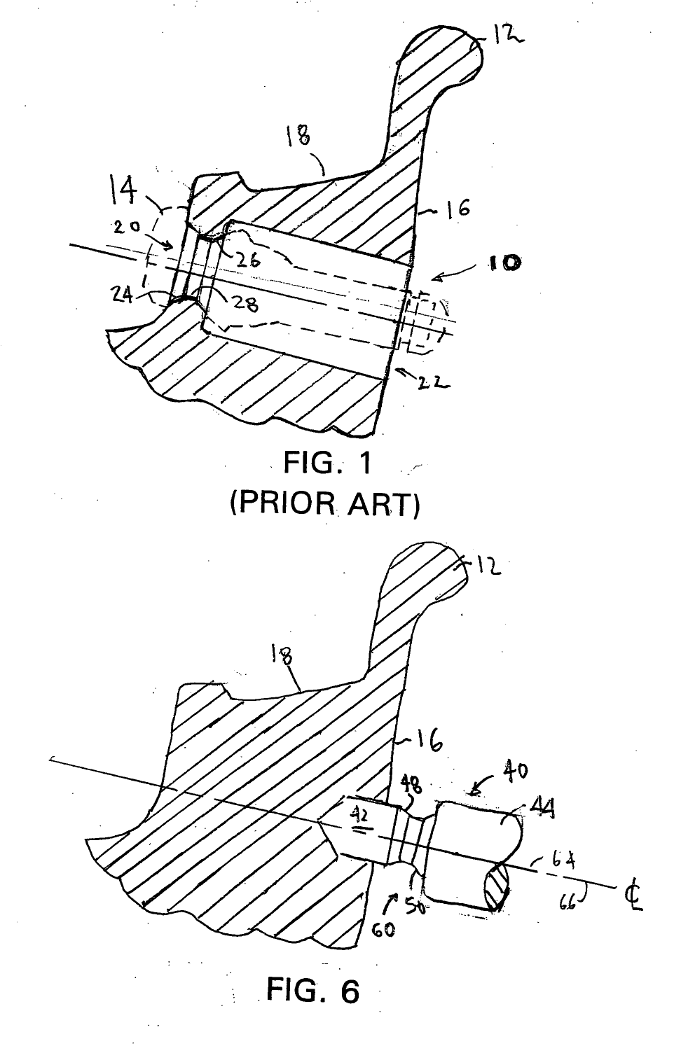

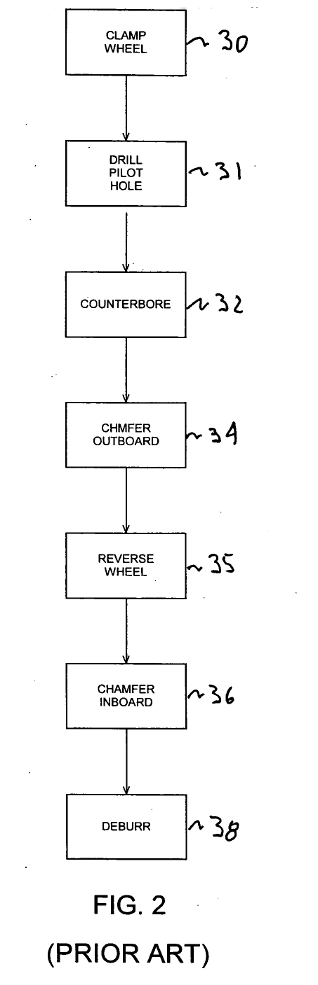

### DETAILED DESCRIPTION

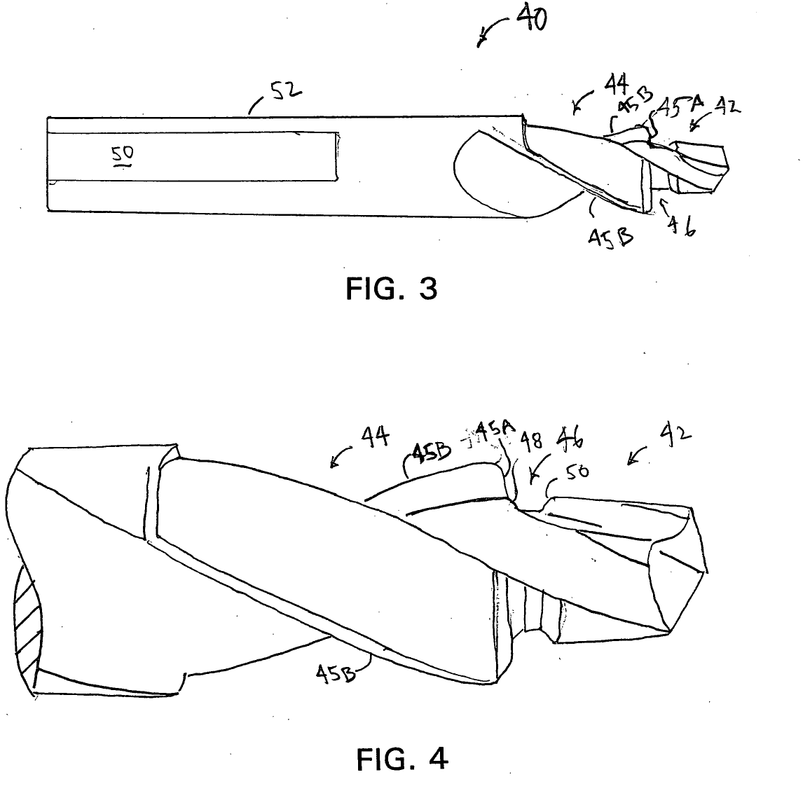

Referring again to the drawings, there is illustrated generally at 40 in FIG. 3, a single tool for forming a valve stem hole through a vehicle wheel sidewall that is in accordance with the invention. In the preferred embodiment, the tool 40 is formed from carbide and includes a end formed as two flute spiral facet style drill 42; however, it will be appreciated that the invention also may be practiced with a tool having more than two flutes (not shown). In the preferred embodiment, the drill point is 135 degrees and has a diameter that corresponds to the diameter of the land 28 formed in the valve stem hole 10. However, it is contemplated that the invention also may be practiced with a tool having a different angle for the drill point.

A stepped cylindrically shaped second portion 44 has a greater diameter than the drill end portion 42 and is used to form the counterbore 22 of the valve stem hole 10. The second portion 22 also is formed with a two flute spiral facet style; however, it will be appreciated that the invention also may be practiced with a tool having more than two flutes formed upon the second portion 22 (not shown). A pair of first cutting edges 45A (one shown) are formed from the shoulder at the right end of the second portion 44 in FIG. 3 and extend radially inward therefrom. As will be explained below, the first pair of cutting edges 45A cut into the wheel sidewall as the tool 40 is advanced in an axial direction into the wheel sidewall 16 to form the counterbore 22. Additionally, a pair of second cutting edges 45B are formed along the edges of the second portion flutes. As also will be explained below, the second cutting edges 45B cut the sides of the counterbore portion of the valve stem hole in a milling type machining operation to enlarge the counterbore 22.

As best seen in the enlargement of the cutting end of the tool 40 shown in FIG. 4, the tool includes a reduced diameter neck 46 that includes an inboard chamfer cutting edge 48, formed upon the right end of second portion 22 in FIG. 4, and an outboard chamfer cutting edge 50 formed upon the left end of the drill 42 in FIG. 4. As will be explained below, the inboard and outboard chamfer cutting edges 48 and 50 are used to form the inboard and outboard chamfers 24 and 28, respectively, in the valve stem hole 10. A pair of flats 50 (one shown) are formed in shank 52 of the tool 40 to facilitate mounting the tool 40 upon a the wheel drilling machine, which is typically a Computer Numerical Control (CNC) machine.

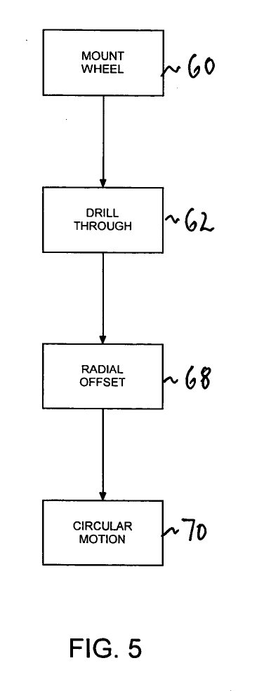

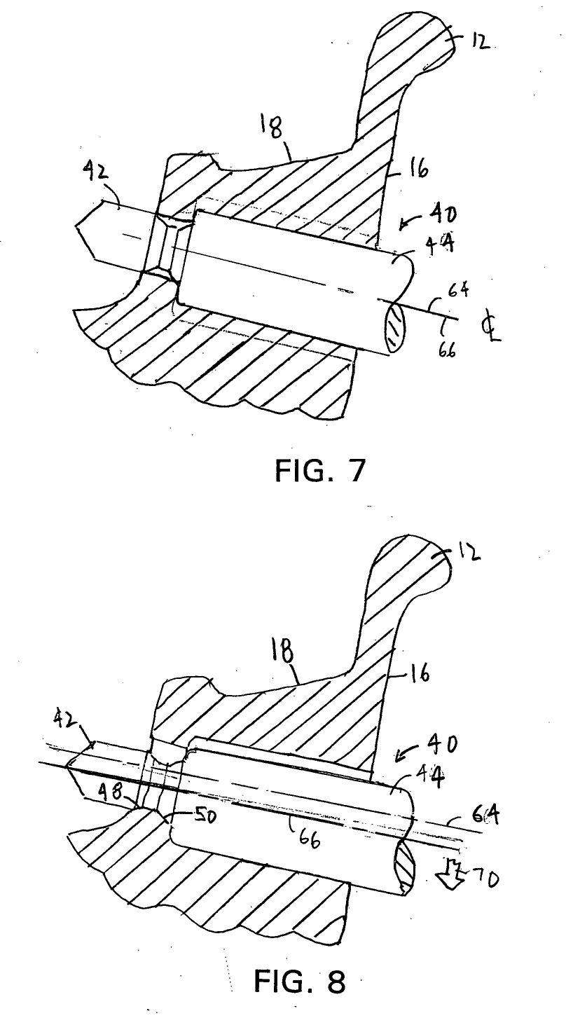

The present invention also contemplates a method for using the tool 40 to form a complete valve stem hole 10. The method is illustrated by the flow chart shown in FIG. 5 and sectional views of a portion of a vehicle wheel sidewall shown in FIGS. 6 through 9. For clarity, the tool 40 is shown in outline in FIGS. 6 through 9. The process begins in functional block 60 with the wheel being mounted upon a wheel drilling machine with the outboard wheel surface exposed to the tool 40 which is mounted upon the drilling machine tool head. Then in functional block 62, the spiral drill point 42 is used to drill a pilot hole completely through the wheel sidewall 16. The beginning of the drilling operation is illustrated in FIG. 6. As the tool 40 advances into the sidewall 16, the first cutting edges 45A formed on the end of the stepped second portion 44 also begin cutting a counterbore into the wheel sidewall. However, the diameter of the counterbore cut by the tool 40 in functional block 62 is less than the final diameter of the valve hole counterbore 22. The completion of the drilling operation and counterbore cutting is illustrated in FIG. 7. As shown in FIGS. 6 and 7, the centerline 64 of the valve stem hole coincides with the centerline 66 of the tool 40 during this initial operation.

In functional 68, the tool 40 is rotated and moved in a radial direction, as shown by the arrow labeled 70 in FIG. 8. As the tool 40 moves in the radial direction, the second cutting edges 45B formed on the sides of the stepped second portion cut into the wall of the counterbore. Additionally, the inboard and outboard chamfer cutting edges 48 and 50 formed at the ends of the tool neck 46 cut into the inboard and outboard ends of the pilot hole. As also shown in FIG. 8, the centerline 66 of the tool 40 is now radially offset from the centerline 64 of the pilot hole.

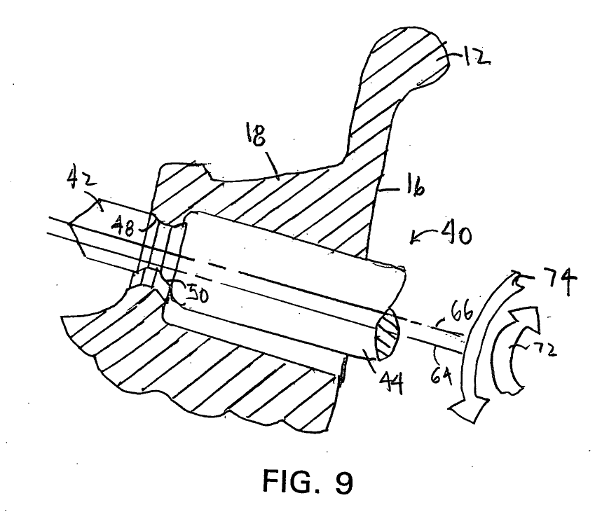

Finally, in functional block 70, the tool 40 continues to be rotated while also moving in a circular arc opposite to the rotational direction of the tool 40, as illustrated in FIG. 9, where the rotation of the tool is identified by the arrow labeled 72 and the direction of the circular arc is identified by the arrow labeled 74. This counter motion produces a climb cutting operation that is similar to milling and first cuts into sidewall of the original diameter to extend the diameter to a final size and then finishes the counterbore 22 by polishing the surface of the counterbore wall. Also, the motion also causes the inboard and outboard chamfer cutting edges 48 and 50 to form the inboard and outboard chamfers 24 and 26, respectively. Additionally, any burrs on the inboard end of the valve stem hole 10 are removed. Alternately, the circular motion can be in same direction as the rotation of the tool to provide a conventional cutting operation (not shown).

The offset radius in functional step 68 is controlled by programming the wheel drilling machine. Selection of the offset radius determines the final diameter of the counterbore and size of the chamfers. Thus, the inventors contemplate that a single tool 40 may be utilized to create a plurality of valve stem holes having different diameters and internal shapes. Additionally, the thickness of the land that seats the valve stem is controlled since the spacing of the chamfers is controlled by the shape of the tool and amount of the offset radius.

While the preferred embodiment has been described as offsetting the tool 40 to the final counterbore radius and then moving the rotating tool in circular arc, it is also contemplated that the invention may be practiced by moving the tool radially in number of incremental steps. Thus, a small amount of material would be removed with each traversal of the counterbore. The incremental radial movement could occur as the same point on the circumference of the counterbore is reached, or continuously as the tool 40 moves through its arc. Alternately, the tool 40 could be continuously moved in a radial direction as it moves through its arc.

As described above, while the preferred embodiment of the invention has been illustrated and described with two flutes, it will be appreciated that the invention also may be practiced with a tool having three or more flutes. Additionally, a counterbore can be formed on the inboard end of the valve stem hole with the drill end 42 of the tool 40 by partially withdrawing the tool 40 and then performing one of the climb cutting or conventional cutting operations described above to form the outboard counterbore 22 (not shown).

The principle and mode of operation of this invention have been explained and illustrated in its preferred embodiment. However, it must be understood that this invention may be practiced otherwise than as specifically explained and illustrated without departing from its spirit or scope. For example, the sides of the drill bit end of the tool can also be positioned to bore out the land portion of the valve stem hole to form a larger diameter for the land.

1. A tool for forming a valve stem hole through the sidewall of a vehicle wheel comprising:
an end portion formed as a spiral fluted drill, said end portion having a first diameter; and
a second portion formed as a counterbore tool having spiral flutes, said second portion having a second diameter that is greater than said first diameter of said end portion.

2. The tool according to claim 1 further including an intermediate portion formed between said end portion and said second portion, said intermediate portion having a diameter that is less than said end portion.

3. The tool according to claim 2 wherein said end portion also includes a first chamfer cutting portion adjacent to said intermediate portion.

4. The tool according to claim 3 wherein said second portion also includes a second chamfer cutting portion adjacent to said intermediate portion.

5. The tool according to claim 2 wherein said third portion also includes a second chamfer cutting portion adjacent to said intermediate portion.

6. The tool according to claim 5 wherein said end portion also includes a first chamfer cutting portion adjacent to said end portion.

7. The tool according to claim 4 wherein said end portion includes at least two flutes.

8. The tool according to claim 7 wherein said second portion includes at least two flutes.

9. A method for forming a valve stem hole through the sidewall of a vehicle wheel comprising the steps of:
(a) providing a tool having an end portion formed as a spiral drill and a second portion formed as a counterbore tool having spiral flutes, the second portion having a larger diameter than the second portion;
(b) using the tool to drill a pilot hole through a wheel sidewall, the second portion of the tool forming a counterbore in one end of the pilot hole;
(c) rotating and moving the tool in a radial direction within the pilot hole; and
(d) moving the tool in a circular motion to increase the size of the counterbore while continuing to rotate the tool.

10. The method according to claim 9 wherein the rotation and circular movement of the tool are in the opposite directions.

11. The method according to claim 9 wherein the rotation and circular movement of the tool are in the same direction.

12. The method according to claim 10 wherein the tool provided in step (a) includes an intermediate neck portion between the end portion and the second portion, the intermediate neck portion including a first chamfer cutting portion adjacent to the end portion of the tool and a second chamfer cutting portion adjacent to the second portion of the tool, and further wherein the first and second chamfer cutting portions are operative during step (d) to cut chamfers upon the surfaces of the pilot hole formed in step (b).

13. A method for forming a valve stem hole through the sidewall of a vehicle wheel comprising the steps of:
(a) providing a tool having an end portion formed as a spiral drill and a second portion formed as a counterbore tool having spiral flutes, the second portion having a larger diameter than the second portion;
(b) using the tool to drill a pilot hole through a wheel sidewall, the second portion of the tool forming a counterbore in one end of the pilot hole; and
(c) rotating and moving the tool in a radial direction within the pilot hole while simultaneously moving the tool in a circular motion to increase the size of the counterbore while continuing to rotate the tool.

14. The method according to claim 13 wherein the rotation and circular movement of the tool are in the opposite directions.

15. The method according to claim 13 wherein the rotation and circular movement of the tool are in the same direction.

16. The method according to claim 14 wherein the tool provided in step (a) includes an intermediate neck portion between the end portion and the second portion, the intermediate neck portion including a first chamfer cutting portion adjacent to the end portion of the tool and a second chamfer cutting portion adjacent to the second portion of the tool, and further wherein the first and second chamfer cutting portions are operative during step (c) to cut chamfers upon the surfaces of the pilot hole formed in step (b).
